(19) United States
(12) Patent Application Publication
(10) Pub. No.: US 2009/0043646 A1
(43) Pub. Date: Feb. 12, 2009

(54) System and Method for the Automated Capture and Clustering of User Activities

(75) Inventors: Gopal Sarma Pingali, Mohegan Lake, NY (US); Mark E. Podlaseck, Kent, CT (US); Sinem Guven, New York, NY (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 11/834,443

(22) Filed: Aug. 6, 2007

(51) Int. Cl. G06F 11/34

(52) U.S. Cl. 705/11

(57) ABSTRACT

An electronic chronicling system and method that allows user actions performed by individuals, groups, or organizations to be automatically captured and grouped into chronicles based on activities, sub-activities and super-activities. The captured activities can then be filtered, viewed and navigated by a visualization and navigation mechanism to determine the relationships between activities and the time and resources spent on the various activities at fine levels of granularity and over various periods of time. The system allows users to gain greater insight into the relationship and resources spent on various activities in order to improve activity and process management efficiencies.

### I. FIELD OF THE INVENTION

This invention relates to an electronic chronicling system and method that allows user actions performed by individuals, groups, or organizations to be automatically captured and grouped into activities, sub-activities and super-activities that can be filtered, viewed and navigated to determine the relationship between and the time and resources spent on the various activities at fine levels of granularity and over long periods of time in order to improve activity management.

### II. BACKGROUND OF THE INVENTION

There currently exists no reliable and efficient means to determine the time spent on different activities by individuals, groups, or organizations at fine levels of granularity and over long periods of time. As a result, individuals are not able to easily review their experiences—the time spent on different activities, their skill and proficiency levels, etc. As a result, groups and organizations are not able to analyze their activities in order to delineate dominant activities, emerging patterns, and other trends which are critical to optimizing operations.

Current approaches to activity capture require users to follow a top-down approach where the users start tasks to be performed under an “activity” label and within the context of a defined “activity”. The problem with this approach is that the user often does not know before hand which “activity” their work relates to or the context of the “activity”—as activities emerge over time. This is complicated further by the fact that a given work/task/event may also be associated with multiple activities.

Notwithstanding the usefulness of the above-described methods, a need still exists for an approach that automatically determines such activities as they emerge over time.

### III. SUMMARY OF THE INVENTION

The present invention in at least one embodiment provides a data processing method, including capturing activities performed by at least one user; clustering the captured activities based on shared commonality; and filtering the captured activities by parameters of interest.

The present invention in at least one embodiment provides a data processing method, including providing one or more captured activities; filtering the captured activities by parameters of interest; navigating the captured activities in order to analyze user activities; and utilizing the captured activities to improve activity management.

The present invention in at least one embodiment provides a visualization and navigation mechanism for browsing captured activities or events in a chronicle repository of a data processing system, including a first navigation bar in communication with a chronicle repository that flexibly focuses a search of events stored in the repository at a first varying degree of abstraction; a second navigation bar in communication with the chronicle repository that flexibly focuses a search of events stored in the repository at a second varying degree of abstraction; and a display window adjacent said first and second navigation bars that displays selected events, wherein the original application of said selected events are launched in said display window by right-clicking the selected event.

The present invention in at least one embodiment provides a computer program product including a computer useable medium including a computer readable program, wherein the computer readable program when executed on a computer causes the computer to capture activities performed by at least one user; cluster the captured activities based on shared commonality; filter the clustered activities by parameters of interest; navigate the filtered activities to analyze the captured activities; and utilize the captured activities to improve activity management.

The present invention, in a variety of exemplary embodiments, provides many advantages to currently available electronic chronicling systems.

The present invention, in at least one exemplary embodiment enables the visualization of actual user events at different levels of abstraction, view key parameters associated with the activities, and follow the evolution of complex activites.

The present invention, in at least one exemplary embodiment enables the ability to select, filter, or group events into clusters based on different event criteria such as time, location, activity type, artifacts involved, and people associated.

The present invention, in at least one exemplary embodiment enables the automatic discover and visualization of event clusters allowing a breakdown of a timeline by different activities.

The present invention, in at least one exemplary embodiment enables the ability to flexibly view activities based on event criteria such as time, location, activity type, artifacts involved, and people associated.

The present invention, in at least one exemplary embodiment enables the ability to create or refine a cluster and have the system discover similar clusters, as well as many other advantages.

### IV. BRIEF DESCRIPTION OF THE DRAWINGS

The present invention is described with reference to the accompanying drawings, wherein:

FIG. 1A illustrates a screenshot of an electronic chronicling system in accordance with an exemplary embodiment of the present invention.

FIG. 1B illustrates an enlarged view of a chronicling bar in accordance with an exemplary embodiment of the present invention.

FIG. 1C illustrates alternative screenshot of an electronic chronicling system in accordance with an exemplary embodiment of the present invention.

FIG. 2 illustrates cluster bars in accordance with an exemplary embodiment of the present invention.

FIG. 3A illustrates an activity visualization and navigation mechanism in accordance with an exemplary embodiment of the present invention.

FIG. 3B illustrates an overview of an activity visualization and navigation system in accordance with an exemplary embodiment of the present invention.

FIG. 3C illustrates a flowchart outlining an overview of the visualization and navigation process in accordance with an exemplary embodiment of the present invention.

FIG. 4 illustrates a flowchart outlining an exemplary chronicling process of the present invention.

FIG. 5 illustrates an automatic clustering process in accordance with an exemplary embodiment of the present invention.

Given the following enabling description of the drawings, the apparatus should become evident to a person of ordinary skill in the art.

### V. DETAILED DESCRIPTION OF THE DRAWINGS

In at least one exemplary embodiment, the present invention provides an activity visualization and navigation system that groups user actions and events based on proximity in time, location, activity type, artifacts involved, and people associated. Cluster visualization, browsing, and editing mechanisms allow users to browse activities at different levels of abstraction; view key parameters associated with the activities; and follow the evolution of complex activities. Activity clustering allows the users to query, filter, and annotate the activities by parameters of interests. Also, activity clustering may be automated and/or user driven and is independent of event navigation.

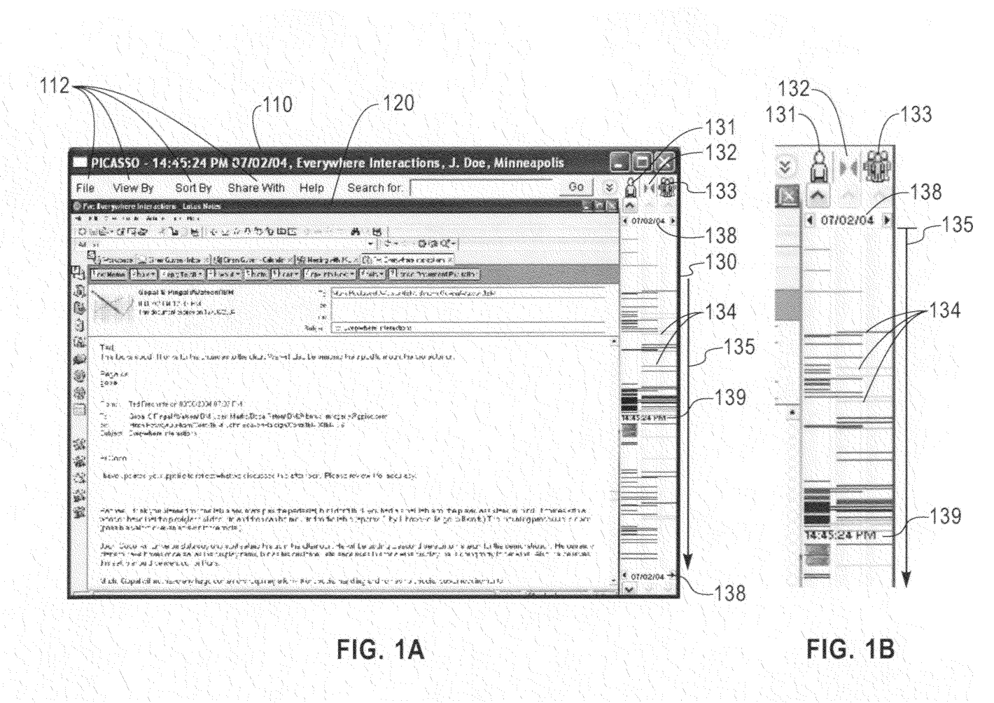

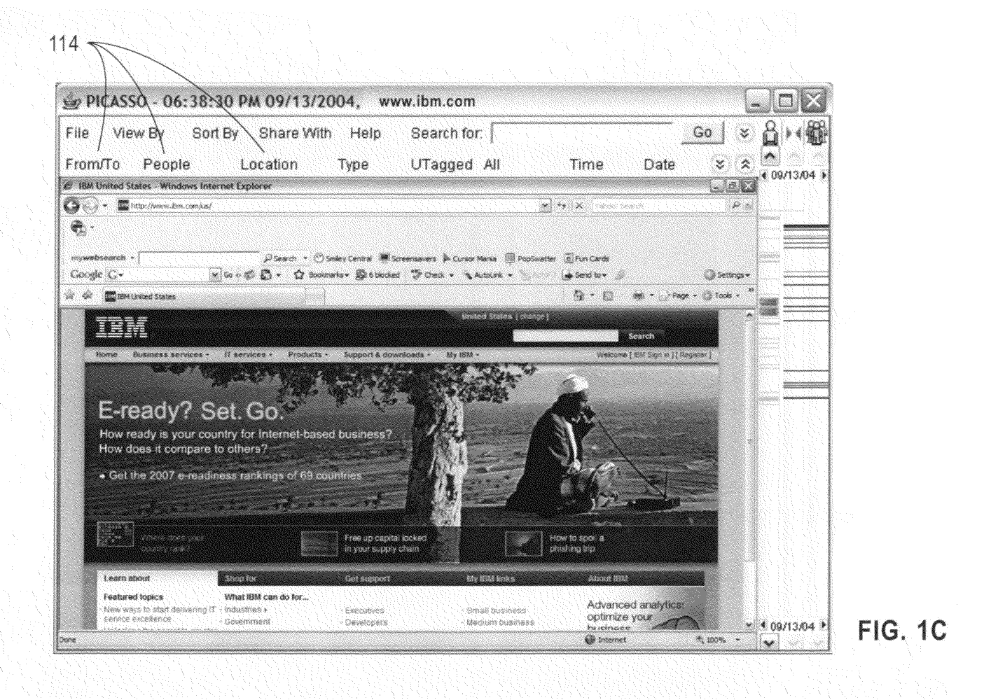

FIG. 1A illustrates an exemplary screenshot of an embodiment of an electronic chronicling system that automatically captures and groups user activities based on the relationship of the activities. The system of the present invention performs several key functions, including: (1) automatically capturing user activities, (2) automatically grouping or clustering the captured activities, and (3) providing a means to visualize and navigate the clustered activities.

The chronicling function allows users to execute their various activities as normal. FIG. 1A illustrates an exemplary main window 110 that incorporates normal functions, for example email activities, being performed in an inset secondary window 120. The main window 110 also includes a menu bar of various filter options 112 that allow users to filter events and control the functionality of the chronicling activities. The system partitions the various activities performed over a selected time period into related groups or clusters that may be optionally viewed in a chronicling bar 130 that may be positioned on the main window 110.

The various filter options 112 may include in a variety of combinations, for example, “File”, “View By”, “Sort By”, “Share With”, and “Help”, as well as a “Search For” function. The “File” option may be used to open or exit a chronicle. The “View By” option may be used to select the time frame of interest, such as day, week, month, year, etc. The “Sort By” option may be used to allow ordering or grouping of events based on different criteria, such as time, location, user or author, type of event, etc. The “Share With” option may be utilized to allow users to share selected events. This sharing may be based on entries in an address book or contact list or by publishing to the public through a mechanism such as a blog. The “Help” option enables a tutorial menu for the chronicle browsing application. The “Search For” option enables searching the events based on keywords associated with the events—either through tags associated with the events or through text of the content associated with events.

The filter options 112 may also include additional filter options 114, which can be, for example, a drop-down or pull-down menu, as illustrated in FIG. 1C. These options may include, for example, any combination of “From/To”, “People”, “Location”, “Type”, “UTagged”, “Time”, and “Date”. The “From/To” option enables users to filter only events that are either received or sent. The “People” option enables events to be selected based on their association with specific people or groups of interest. For example, selecting the “From” option and selecting person “X” from the people options shows only events from person “X” in the chronicling bar 130. The “Location” option enables the selection of events that occurred only in particular locations. The “Type” option enables selection of the events based on activity type, such as “email sent”, “document edited”, “chat session”, “website browsed”, “image taken”, etc. The “UTagged” option enables selection of events based on whether user tags are associated with the event. The “Time” and “Date” options enable selection of events based on time and/or date of interest.

The chronicling bar 130, as exemplarily illustrated in the enlarged view in FIG. 1 B, provides a means of cluster visualization wherein user activities and events are clustered based on various definable proximity parameters. Examples of these activities include communications used, such as voice over internet protocol (VoIP), email and text messages, websites visited, programs/software packages used, peripheral devices used, as well as any other user actions. The proximity parameters may include time, space or location, artifacts involved, people associated, or other similar criteria. The proximity parameters are fully user selectable and may be stored or applied ad hoc.

The chronicling bar 130 is partitioned to include several proximity parameters including, for example, user activities 131, outgoing/incoming activities 132, and shared activities or group 133. The chronicling bar 130 includes a period of interest or date stamp 138, a timeline 135 that runs along the chronicling bar 130, and a timestamp 139 along the timeline 135. The chronicling bar 130 includes various events that are represented by event bars 134. These event bars 134 may be distinguished by color or other differentiating means. The capture, clustering and visualization/navigation of these activities provided by the system allow users to view all business activities performed for a particular time period. The clustering of activities results in revealing key performance indicators, causal relationships, and commonality of events, such as dominant activities, emerging patterns, and events preceding or following certain activities. The clustering may also reveal an association of activities that may not otherwise be readily apparent, for example associating different activities with different periods of time or associating activities that may not be related by organization. This insight into the various business activities and processes allows users to improve business activity and process management efficiencies based on the activity history or chronicle.

FIG. 1B illustrates an enlarged view of chronicling bar 130. In this example, the chronicle bar 130 lists selected events 134 during a particular period of interest of Jul. 2, 2004 (shown in date stamp 138). The chronicle bar 130 includes several proximity parameters 131, 132, 133 along the top. Proximity parameter 131 charts the activities of a particular user. These activities may be sorted to display the activities of an individual user, a group of users or an entire organization of users. All activities performed by the specified user may be captured and displayed. Proximity parameter 132 charts the route of activities, i.e., whether they are outgoing or incoming. This parameter allows activities to be sorted based on whether they are sent or received by an individual user, group or organization. For example, communications such as email, text messages or file attachments may be sorted to illustrate their origin or destination. Proximity parameter 133 charts which activities have shared commonality of users. This parameter allows activities to be sorted based on groups, subgroups or supergroups and illustrates how the activities are shared amongst these users. By utilizing the function of the chronicling bar 130, activities may be sorted by a commonality of group or by commonality of activity.

The proximity parameters 131, 132, 133 are charted by events 134 along the timeline 135 to provide a visual indication of captured events. These captured events represent what activities have been performed. The timeline 135 is adjustable to indicate activities over certain periods of time, for example a particular day, week or month. The event bars 134 along the timeline 135 represent when the activities were performed and may be distinguished by color or other differentiating means wherein related activities or activity attributes share common colors based on, for example, location, user(s) involved, type of activity, etc. Users can browse, view, and edit the activities by scrolling along the timeline 135 of event bars 134 that represent captured activities. Users can move a cursor along any of the columns of proximity parameters 131, 132, or 133 to navigate the timeline 135 and view details of a selected event. The secondary window 120 shows a screenshot image corresponding to the current event selected on the timeline 135. While the present embodiment is described with respect to a screenshot, a variety of representations of may be utilized to indicate and/or distinguish events, including still or animated images, pictures, symbols, logos, icons, marks, bars, colors, shading or grading, or the like.

The selected event in FIG. 1A shows a representation (such as the file contents, image or preview, or screenshot) of an email sent by the user on Jul. 2, 2004 (Jul. 02, 2004) at 2:45:24 PM (14:45:24 PM). The selected event in FIG. 1C shows a representation of a website browsed by the user on Sep. 13, 2004 (Sep. 13, 2004) at 06:38:30 PM. Similarly, as the user navigates along the timeline, the image in the secondary window 120 changes to correspond to the event bars 134 being browsed. For example, as the user navigates the chronicle 130, the secondary window 120 may show the representation of a document, chat session, presentation, browsed website, or downloaded file such as a document, image, or video. Further, while the illustrated secondary window 120 only shows a screenshot of the selected event 134, the original application (website, program, etc.) can be launched by right-clicking on the secondary window 120 and making a selection. For example, the user can browse events 134 in the chronicle bar 130, view a selected chronicled activity (e.g., a Microsoft® Office PowerPoint® presentation) in the secondary window 120 and then launch the original activity (PowerPoint® presentation) by right-clicking on the secondary window 120. The user may also annotate an event 134 with any number and/or combination of tags at any time. Similarly, these tags can be written on top of the representation and at any position, for example, by moving the mouse to a selected position, right-clicking, and selecting the appropriate tag option.

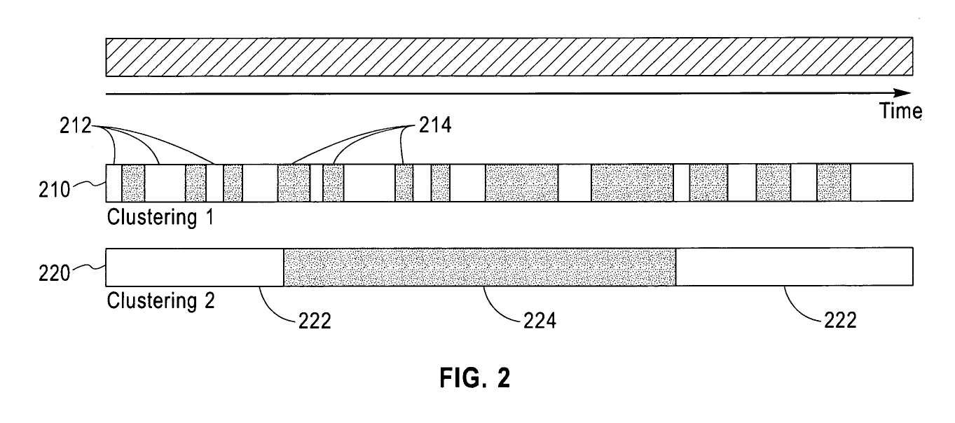

FIG. 2 illustrates exemplary cluster bars used with an embodiment of the present system. The system creates the cluster bar 210 by clustering the captured activities represented by the event bars 134. The cluster bar 210 illustrates groups of captured activity clusters 212, 214 organized based on user selection criteria. Cluster bar 220 illustrates a higher level of cluster grouping wherein the clusters 222, 224 each represents a set of activities. Similar to the event bars 134, the activity clusters illustrated on cluster bars 210, 220 are filtered into activity blocks that are distinguished by color or other differentiating means wherein related activities share a common color. For example, clusters 222 may represent all activities related to communication and cluster 224 may represent all activities related to research. While two groups are shown in this exemplary embodiment, the settings may be adjusted to indicate any number of activity groups representing related activities. The cluster bars 210, 220 provide a quick visual indication of the types and relative amounts of activities performed.

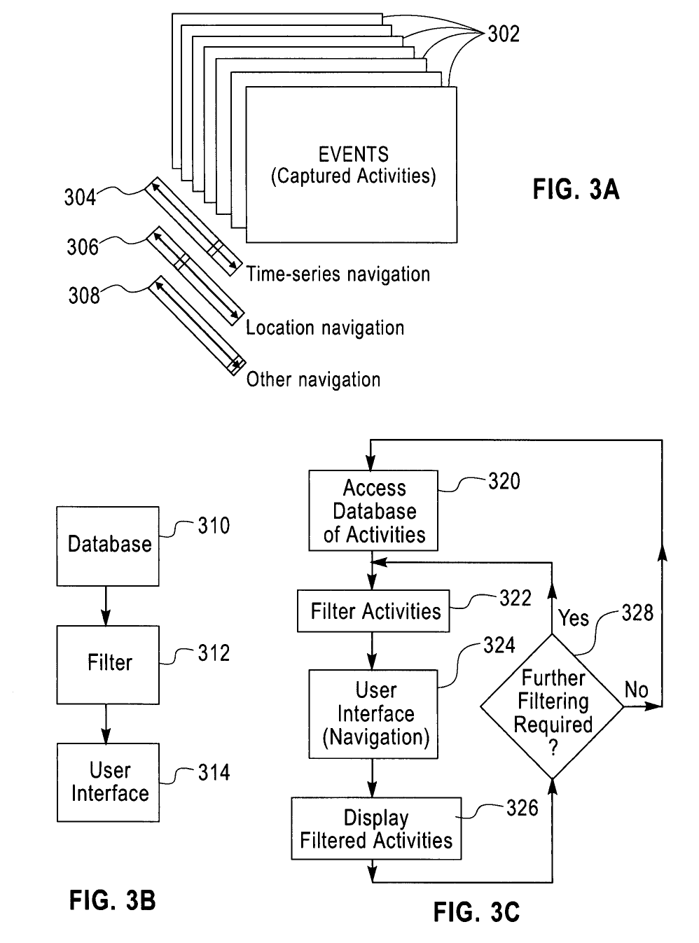

FIG. 3A illustrates an exemplary embodiment of an activity visualization and navigation mechanism of the present system. The activity visualization and navigation mechanism allows users to browse the captured activities (e.g., event records) 302. Browsing is performed by the visualization and navigation mechanism by zooming into and out of the activity groupings at different levels of abstraction. The varying level of abstraction allows users to view key parameters associated with the activities and follow the evolution of complex activities.

The visualization and navigation mechanism provides various navigation bars 304, 306, 308 that enable the broad range of abstraction when viewing the activities. The time series navigation bar 306 allows users to flexibly perform focused searches of the captured activities 302 over varying periods of time. The location navigation bar 306 allows users to search the captured activities 302 based on the location of the user. The other navigation bar 308 can be set based on a variety of user settings to provide users with the flexibility to provide additional search criteria to further focus the search of captured activities. While three navigation bars are shown in this exemplary embodiment, the visualization and navigation mechanism may include any number of navigation bars in order to perform varying levels of focused searches of the captured activities 302. The visualization and navigation mechanism enables monitoring, summarizing, and tracking different attributes of captured activities 302, such as identifying and analyzing common sequences of activities and estimating causal relationships between activities.

FIG. 3B illustrates an overview of an embodiment of the visualization and navigation system of the present invention. The visualization and navigation system includes a database 310, filter 312, and user interface 314. Captured activities are stored on database 310 based on preset or dynamic functions. Filter 312 is in communication with the database 310 and enables preset and dynamic sorting (clustering) functions to be supplied to the database 310. Filter 312 utilizes filter options 112, 114, discussed above, to sort and focus the events 302 based on the selected criteria. User interface 314 may include navigation bars 304, 306, 308 and secondary window 120 in communication with filter 312. User interface 314 allows user navigation and display of the captured activities enabling sorting functions to be supplied to the database 310 via filter 312. These sorting functions allows the activities (e.g., communications used, email and text messages, websites visited, programs/software packages used, peripheral devices used, etc.) and proximity parameters (e.g., time, space or location, artifacts involved, people associated, or other similar criteria) to be grouped into activities, sub-activities and super-activities that can be filtered, viewed and navigated at fine levels of granularity and over long periods of time such that activity management might be optimized.

FIG. 3C illustrates a flowchart of an exemplary overview of the visualization and navigation process of the present invention. The process begins at 320 as the system accesses a database or chronicle of captured activities. At 322, the captured activities are filtered by stored or dynamic parameters. At 324, a user interface is utilized to navigate the filtered activities. At 326, the filtered activities are displayed for visualization by user. At 328, a determination is made as to whether additional filtering of the selected activities is required. If yes, the process returns to 322 and additional filtering is performed. If no, the process returns to 320 and accesses the database of activities.

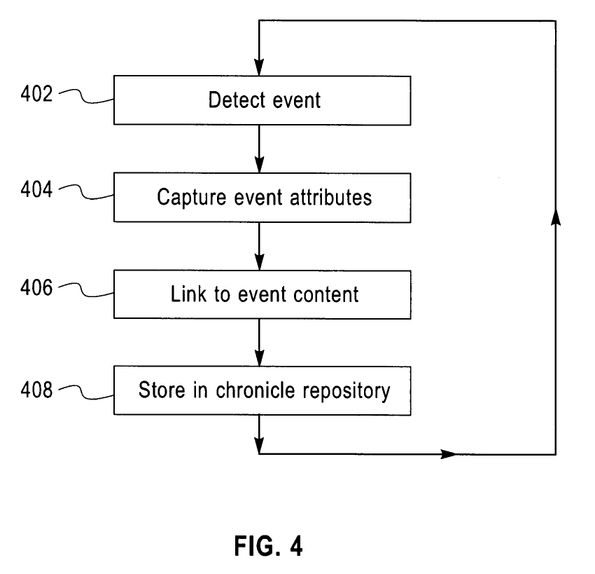

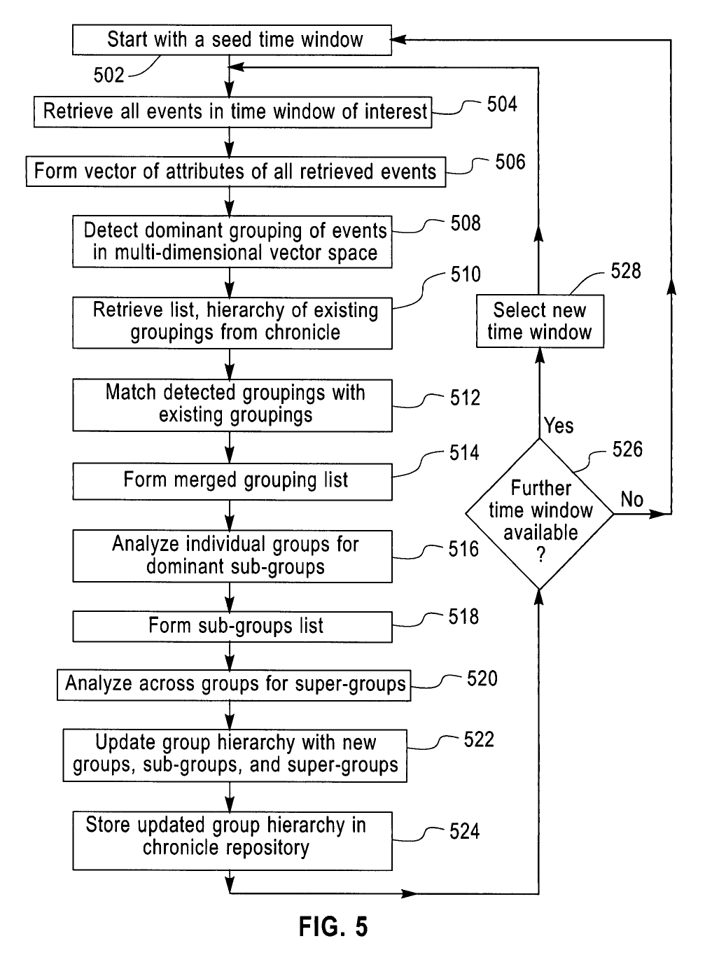

FIG. 4 illustrates an exemplary activity chronicling process of the present invention. The chronicling process outlines how activities are detected and stored by the system such that they may be visualized and browsed. The system utilizes the filter options 112 and additional filter options 114, as illustrated in FIG. 1A and 1C, respectively, to filter the events and/or control the functionality of the chronicling activities performed by the chronicling process, illustrated in FIG. 4, and the automatic clustering process, illustrated in FIG. 5.

The chronicling process begins at 402 as the system detects events including, for example, documents being opened or saved, websites being browsed, email sent or received, and the like. At 404, the system captures attributes of the events including, for example, metadata of the main content such as user or author, activity type, name (document, email, etc.), date and time created or saved, machine created on, location, etc. At 406, the system creates links to the metadata or actual content. At 408, the system stores the events, attributes and links into a chronicle repository such that it may be used by an activity visualization and navigation system.

A data processing system may be utilized to perform the activity chronicling processes outlined above. An exemplary data processing system for executing the activity chronicling process may include, for example, at least one electronic chronicling capture tool; an electronic chronicle repository in communication with the electronic chronicling capture tool; a chronicle navigator in communication with the electronic chronicle repository; and an analysis and mining tool in communication with the electronic chronicle repository. The electronic chronicling capture tool runs on various end devices and captures selected activities as they are performed. The electronic chronicle repository stores and organizes the captured activities based on contextual dimensions and proximity parameters. The chronicle navigator enables the analysis and utilization of the captured activities stored in the chronicle repository. The analysis and mining tool is in communication with the chronicle repository and may generate statistical summaries and analyses of the captured activities. This exemplary data processing system provides a chronicle of captured activities that can be accessed, filtered, viewed, and navigated by the visualization and navigation mechanism of the present invention.

FIG. 5 illustrates an exemplary automatic clustering process of the present invention. The automatic clustering process begins at 502 with a time window of interest. At 504, the system retrieves all events in the time window of interest. At 506, the system forms a vector of attributes of all retrieved events. At 508, the system detects dominant groupings of events in multi-dimensional vector space. At 510, the system retrieves a list outlining the hierarchy of existing groupings from chronicle. At 512, the system matches the detected groupings with existing groupings. At 514, the system forms a merged grouping list. At 516, the system analyzes individual groups for dominant subgroups. At 518, the system forms a list of subgroups. At 520, the system analyzes across groups for super-groups. At 522, the system updates group hierarchy with new groups, subgroups, and super-groups. At 524, the system stores the updated group hierarchy in the chronicle repository. At 526, the system determines whether there are more available time windows of interest. If yes, the system proceeds to 528, selects a new time window, and proceeds to 504. If no, the system proceeds to 502.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A data processing method, comprising:
capturing activities performed by at least one user;
clustering said captured activities based on shared commonality; and
filtering said captured activities by parameters of interest.

2. The data processing method according to claim 1, wherein said captured activities include one or more events occurring on at least one computer.

3. The data processing method according to claim 1, further comprising:
visualizing and navigating said captured activities in a chronicle bar and window at different levels of abstraction.

4. The data processing method according to claim 3, wherein said chronicle bar includes proximity parameters that further identify and define said captured activity.

5. The data processing method according to claim 4, wherein said proximity parameters include user or author, applications used, activity type, activity location, time, and artifacts involved.

6. The data processing method according to claim 3, wherein said window includes flexible menu options that selectively filter user events and control the functionality of activity capturing.

7. The data processing method according to claim 6, wherein said events include user activities, outgoing activities, incoming activities, shared activities, and group activities.

8. The data processing method according to claim 2, further comprising: displaying a representation of a selected captured activity in a window.

9. The data processing method according to claim 8, further comprising: launching the original application of said selected captured activity.

10. A data processing method, comprising:
providing one or more captured activities;
filtering said captured activities by parameters of interest;
navigating said captured activities in order to analyze user activities; and
utilizing said captured activities to improve activity management.

11. The data processing method according to claim 10, wherein said captured activities are performed by at least one user and clustered based on shared commonality.

12. The data processing method according to claim 10, further comprising:
visualizing and navigating said captured activities in a chronicle bar and window at different levels of abstraction.

13. The data processing method according to claim 12, wherein said chronicle bar includes proximity parameters.

14. The data processing method according to claim 13, wherein said proximity parameters include at least one of user or author, applications used, activity type, activity location, time, and artifacts involved.

15. The data processing method according to claim 12, wherein said window includes flexible menu options that selectively filter user events and control the functionality of activity capturing.

16. The data processing method according to claim 15, wherein said events include at least one of user activities, outgoing activities, incoming activities, shared activities, and group activities.

17. A visualization and navigation mechanism for browsing captured activities or events in a chronicle repository of a data processing system, comprising:
a first navigation bar in communication with a chronicle repository that flexibly focuses a search of events stored in said repository at a first varying degree of abstraction;
a second navigation bar in communication with said chronicle repository that flexibly focuses a search of events stored in said repository at a second varying degree of abstraction; and
a display window adjacent said first and second navigation bars that displays selected events, wherein the original application of said selected events are launched in said display window by right-clicking the selected event.

18. The visualization and navigation mechanism according to claim 17, further comprising:
at least one additional navigation bar in communication with said chronicle repository that flexibly focuses a search of events stored in said repository at an additional varying degree of abstraction.

19. The visualization and navigation mechanism according to claim 17, wherein said varying degrees of abstraction include at least one of user or author, applications used, activity type, activity location, time, and artifacts involved.

20. A computer program product comprising a computer useable medium including a computer readable program, wherein the computer readable program when executed on a computer causes the computer to:
capture activities performed by at least one user;
cluster said captured activities based on shared commonality;
filter said clustered activities by parameters of interest;
navigate said filtered activities to analyze said captured activities; and
utilize said captured activities to improve activity management.
